(19) United States
(12) Patent Application Publication
(10) Pub. No.: US 2025/0313518 A1
(43) Pub. Date: Oct. 9, 2025

(54) COLLOIDAL PHOSPHATE FERTILIZER WITH LIMITED RUN-OFF AND METHOD OF MAKING SAME

(71) Applicant: The Andersons Inc., Maumee, OH (US)

(72) Inventors: Barry Fanning, Maumee, OH (US); Alanna Knight, Maumee, OH (US); Ciara Patterson, Maumee, OH (US); Charles W. Anderson, Maumee, OH (US)

(73) Assignee: The Andersons Inc., Maumee, OH (US)

(21) Appl. No.: 19/095,447

(22) Filed: Mar. 31, 2025

Related U.S. Application Data
(60) Provisional application No. 63/573,538, filed on Apr. 3, 2024.

(51) Int. Cl. C05G 5/27; A01C 21/00; C05B 17/00; C05F 11/08

(52) U.S. Cl. CPC C05G 5/27; A01C 21/00; C05B 17/00; C05F 11/08

(57) ABSTRACT

A fertilizer is provided that promotes plant growth with limited phosphate run-off. The fertilizer has reduced run-off even when compared to a phosphorus normalized application of struvite. The fertilizer is based on suspended colloidal particles in aqueous solution. The colloidal particles have a size distribution in which 95 percent of the colloidal particles are less than 60 microns and have an atomic number ratio of magnesium:nitrogen:phosphorus of 1:0-3:0.5-3. The colloidal particles are heterogeneous and include domains of only struvite, or of struvite in combination with domains of pyrophosphate species, poly phosphate species, or combinations thereof. The fertilizer composition is formulated to include additional components while still retaining colloidal suspension storage stability. The colloidal particles are produced from concentrated solutions that facilitate industrial scale production. The colloidal particles promote bioavailability through root acid phosphatases activation of insoluble phosphorus species. The colloid domain size facilitates access and soil intercalation over run-off mechanisms.

### RELATED APPLICATIONS

This application claims priority benefit of U.S. Provisional Application Ser. No. 63/573,538 filed 3 Apr. 2024; the contents of which are hereby incorporated by reference.

### FIELD OF THE INVENTION

The present invention in general relates to fertilizer to promote plant growth, and in particular, to a colloidal phosphate fertilizer that overcomes many of the problems associated with conventional phosphate fertilizers.

### BACKGROUND OF THE INVENTION

Phosphate in water has been a growing environmental problem as a result of the increased amount of phosphate entering bodies of water from point and nonpoint sources. One specific problem related to waste phosphorus is surface water eutrophication. The eutrophication of bodies of water has many negative effects on the aquatic biome and can eventually lead to severe economic, environmental, and human health problems. An increase in the amount of phosphates in a body of water leads to the growth of aquatic weeds and algae (algae bloom). An algae bloom decreases the amount of oxygen in the water and decreases the visibility because of increased surface plant growth, which causes the elimination of bottom-dwelling plants and organisms. The use of the body of water is then discontinued for recreational purposes while cost of maintenance increases. The decreased amount of dissolved oxygen in water is a result of the increased amount of microbial growth that feeds off of plant residues. Algae blooms and fish deaths compound the anerobic damage to the ecosystem.

Phosphate run-off into bodies of water have many sources including fertilizers. Fertilizer run-off is problematic in adding to the cost of crop production and then causing environmental problems downstream. This problem is exacerbated by usage of highly water-soluble phosphate fertilizers based on the belief that insoluble phosphates cannot be absorbed by target plant crops. Unfortunately, water soluble phosphates are readily dissolved by rainwater and irrigation run-off to contaminate downstream bodies of water.

Struvite (magnesium ammonium phosphate hexahydrate) is a naturally-occurring mineral found in manure and guano. Struvite routinely causes problems in wastewater treatment plants owing the insolubility thereof in water, resulting in pipe clogging. With the exception of dispersible struvite particles such as those detailed in U.S. Pat. Nos. 8,609,145 and 9,624,139; struvite has been discounted as a phosphate fertilizer. While these particles have limited phosphate run-off owing to the slow-release kinetics and the ability of granules of struvite to disperse into soil, there are many settings where a liquid fertilizer is required.

Thus, there exists a need for a colloidal suspension of low water solubility phosphates that are bioavailable to plants that are amenable to liquid application, while further limiting phosphate run-off. There further exists a need for a method to produce the colloidal suspension at scale under high osmolality precursor conditions. There further exists a need for the ability to modify the colloidal suspension to a concentrate or powder that is amenable to resuspension prior to field application.

### SUMMARY OF THE INVENTION

A fertilizer composition is provided that includes an aqueous solution and colloidal particles suspended in the aqueous solution. The colloidal particles have a size distribution in which 95 number percent of the colloidal particles are less than 60 microns and have at atomic number ratio of magnesium:nitrogen:phosphorus of 1:0-3:0.5-3.

A kit is provided for a fertilizer composition with the colloidal particles as described above, and instructions for how to suspend the colloidal particles in water to form an aqueous suspension, and apply the aqueous suspension to a field as a fertilizer.

A method is provided for forming a fertilizer composition. The method includes forming a magnesium aqueous solution having a magnesium solution pH of between 4 and 10 through addition of ammonium. Subsequently, an aqueous solution of phosphate, polyphosphate, pyrophosphate, or combination thereof is added to the magnesium aqueous solution to form a solution pH of between 4 and 10 to form colloidal particles having a size distribution in which 95 number percent of the colloidal particles are less than 60 microns and having at atomic number ratio of magnesium:nitrogen:phosphorus of 1:0-3:0.5-3.

A process of fertilizing a crop is provided. The process includes applying a fertilizer composition with the colloidal particles as described above to the crop, and allowing sufficient time for the composition to promote growth of the crop.

### BRIEF DESCRIPTION OF THE DRAWINGS

Examples illustrative of embodiments are described below with reference to figures attached hereto. In the figures, identical structures, elements or parts that appear in more than one figure are generally labeled with the same numeral in all the figures in which they appear. Dimensions of components and features shown in the figures are generally chosen for convenience and clarity of presentation and are not necessarily shown to scale. The figures are listed below.

FIG. 1 is a schematic, cross-sectional view of an inventive colloidal particle;

FIG. 2 is a schematic flow chart for a process of producing an inventive composition; and

FIG. 3 is a plot of phosphate run-off for an inventive composition relative to comparative, conventional compositions.

### DESCRIPTION OF THE INVENTION

The present invention has utility as a fertilizer to promote plant growth with limited phosphate run-off. In some inventive embodiments, an inventive fertilizer has reduced run-off even compared to a phosphorus normalized application of struvite. The present invention is based on colloidal particles suspended in an aqueous solution. The colloidal particles have a size distribution in which 95 number percent of the colloidal particles are less than 60 microns and having an atomic number ratio of magnesium:nitrogen:phosphorus of 1:0-3:0.5-3. The colloidal particles in some inventive embodiments are heterogeneous and include domains of only struvite, or of struvite in combination with domains of pyrophosphate species, poly phosphate species, or combinations thereof. An inventive composition is also readily formulated to include additional components while still retaining colloidal suspension storage stability. The colloidal particles are readily produced from concentrated solutions that facilitate industrial scale production. Without intending to be owned by a particular theory, the inventive colloidal particles promote bioavailability through root acid phosphatases activation of insoluble phosphorus species. The domain size of the inventive colloids facilitating access and soil intercalation over run-off mechanisms.

As used herein, “pyrophosphate” is defined as inclusive of the anion P₂O₇⁴⁻ and referred to herein synonymously as “diphosphate” or “pyrometaphosphate”.

As used herein, “polyphosphate” is defined as inclusive of the polyanion [PO₃]ₙ¹⁻, where n is an integer value of between 4 and 5,000. Common cations of polyphosphate include alkali metals; alkali earths; oniums such as NH₄⁺ and H⁺, and combinations thereof.

As used herein, “phosphate” is defined as inclusive of the anion PO₄³⁻.

As used herein, the plural “phosphates” is defined as including any combination of “phosphate”, “pyrophosphate”, and “polymetaphosphate”.

As used herein, “plant available phosphorus” is defined by the methods detailed in Mehlich, A. 1984. Mehlich 3 soil test extractant: A modification of Mehlich 2 extractant. Commun. Soil Sci. Plant Anal. 15:1409-1416.

As used herein, “stable suspension” is defined as a kinetic precipitation of less than 2 weight percent of the colloidal particles at standard temperature and pressure over 14 days.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

In certain inventive embodiments, a fertilizer is provided that has NPK over the range of 0-16:1-28:0-16 through the selection of ammonium and potassium containing cations for phosphates present in an inventive colloidal particle, respectively. It is appreciated that through selection of cations and the stoichiometries of the phosphates present, an inventive composition is readily varied relative to the magnesium:nitrogen:phosphorus atomic ratio of 1:1:1 associated with struvite. Inclusion of potassium ions such as the base KOH; the nitrogen source ammonia (NH₄OH in aqueous solution), urea, and uric acid; but also with bases that do not contribute to the NPK value of the resultant fertilizer allow for modification of the NPK value of the inventive colloidal compositions. Such non-NPK contributing bases operative herein illustratively include sodium hydroxide, sodium carbonate, sodium bicarbonate, sodium hydrogencarbonate, calcium oxide, calcium oxide hydrates (calcium hydroxide), magnesium oxide, calcium carbonates, magnesium oxide hydrates (magnesium hydroxide), magnesium carbonates, and combinations thereof, and partially neutralized compounds thereof. Regardless of the specific composition of the inventive composition, the solubility constant (k) of the inventive colloidal composition is less than 10⁻³ in order to inhibit run-off of phosphate. In still other inventive embodiments, the solubility constant is between 10⁻⁴ and 10⁻¹⁵.

Through selection of the ratio of various phosphates present in an inventive colloid, as well as any additional phosphates present in the aqueous solution in which the colloids are suspended, the ratio of plant available phosphorus to total phosphorus is readily varied between 0.2-1:1.

The inventive colloidal particles have a size distribution in which 90 number percent of the colloidal particles are between 0.2 and 50 microns. In still other inventive embodiments, the colloidal particles have a size distribution in which 80 number percent of the colloidal particles are between 8 and 30 microns. Without intending to be bound to a particular theory, it is believed that particles with these dimensionalities strike a balance as to charge stabilization to maintain the colloids in suspension, intercalate into most soils and into contact with target crop roots and soil microbes, and undergo phosphates dissolution by substances excreted by plants and soil microbes. Plant root acidic phosphatases are believed to play an important role in dissolution of colloidal magnesium and phosphates, as compared to an ion exchange mechanism. MM Aslam, et al. “Root acid phosphatases and rhizobacteria synergistically enhance white lupin and rice phosphorus acquisition.” Plant Physiology 190.4 (2022): 2449-2465. As the inventive colloids are largely insoluble absent plant or microbe excreted enzymes, run-off of unreacted inventive colloids is limited, evidence which is provided hereafter.

In order to efficiently transport and disperse an inventive composition, the colloidal particles are present from 2 to 99 weight percent of an aqueous suspension, and in still other embodiments, from 25 to 90 weight percent. It is appreciated that an inventive composition can include additional components that illustratively include a stabilizer, micronutrients, plant growth modifiers, additional fertilizer NPK components, and combinations thereof; and while these count towards a total weight percentage, these additional components are not counted toward the weight percent of inventive colloids in an aqueous solution.

The pH of an inventive composition is typically between 3 and 11, and in other embodiments is between 5 and 9. In these pH ranges, the inventive colloids form a stable suspension. In certain inventive embodiments, a pH buffering agent is present in an amount to stabilize composition pH. pH modifiers operative herein illustratively include soda ash, sodium hydroxide, sodium silicate, sodium phosphates, lime, and sulfuric acid. pH buffering agents operative herein illustratively include citrates, acetates, humates, folates, nitrates, sulfates, and combinations thereof.

An inventive composition in some inventive embodiments also includes a stabilizer that functions to thicken the aqueous solution. Stabilizers operative herein illustratively include xatham gum, guar gum, a starch, agarose, a water soluble cellulosic, pectin, gelatin, clay, xanthan gum, methyl cellulose, methyl hydroxyethyl cellulose, microfibrillated cellulose, butyl glucoside, polyvinyl alcohol, micaceous powders, carboxymethyl cellulose, or a combination thereof. Typically, each stabilizer is present in the range from 0.001-10 total weight percent of an inventive composition, with the total amount of stabilizer typically being such that the composition viscosity is less than 250,000 centipoises.

An inventive composition in some inventive embodiments also includes at least one micronutrient trace metal dissolved in the aqueous solution of an inventive composition in the form of a water soluble salt or a chelate thereof. Micronutrient trace metals known to function as co-enzymes or otherwise promote plant growth include calcium, cobalt, iron, manganese, copper, chromium, boron, zinc, and molybdenum. Typically, each micronutrient is present in the range from 0.00001-5; where total weight percentages are for the trace micronutrient cation itself and therefore excludes the weight contribution of chelating agents or anions or hydrates. It is appreciated that the amount of micronutrient is readily titrated to adjust for specific soil conditions. Water soluble metal chelates of the micronutrients present in an inventive liquid fertilizer illustratively include ethylenediamine disuccinic acid (EDDS), ethylenediamine dimalonic acid (EDDM), and ethylenediamine diglutaric acid (EDDG), ethylenediaminetetraacetic acid (EDTA), diethylenetriaminepentaacetic acid (DTPA), nitrilotriacetic acid (NTA), iminodiacetic acid (IDA), iminotriacetic acid (ITA), ethylenediamine (En), N,N′-diethylenediamine (Den), diethylenetriamine (DTN), diethylenetetramine (Trien), triaminotriethylene amine, triethanolamine, malonic acid, succinic acid, glutaric acid, citric acid, fumaric acid, maleic acid, polyols, polyamines, amino acids, polypeptides, polyaspartate, polylactate, and aconitic acid. It is appreciated that while EDTA represents a most commonly used chelating agent, the problems associated therewith as a bio-accumulant are obviated by using a biodegradable chelating agent such as EDDS or EDDG.

An inventive composition in some inventive embodiments also includes plant growth modifiers that are a functional hormone or protein with activity towards a target plant. Plant growth modifiers operative herein illustratively include indole-3-butyric acid, root acid phosphatase, cytokinins, auxins, abscisic acid, gibberellins, amino acids, carboxylic acids or salts, Karrikin's, naphthalene carboxylic acid, or a combination thereof. Root acid phosphatase is particularly advantageous in stimulating uptake of phosphor from inventive colloids that would otherwise have low solubility in water. Typically, plant growth modifiers are present at trace levels of 10⁻¹⁰ to 10⁻⁴ total weight percent of an inventive composition.

An inventive composition in some inventive embodiments also includes an additional NPK fertilizer with the proviso that the additional fertilizer is soluble in the aqueous solution. Soluble fertilizers operative herein illustratively include urea, isobutylidene diurea, ammonium nitrate, ammonium sulfate, potassium sulphate, sodium nitrate, potassium nitrate, potassium chloride, dipotassium carbonate, potassium oxide, and a combination thereof. The additional fertilizer being present in an amount to adjust the NPK of an inventive composition.

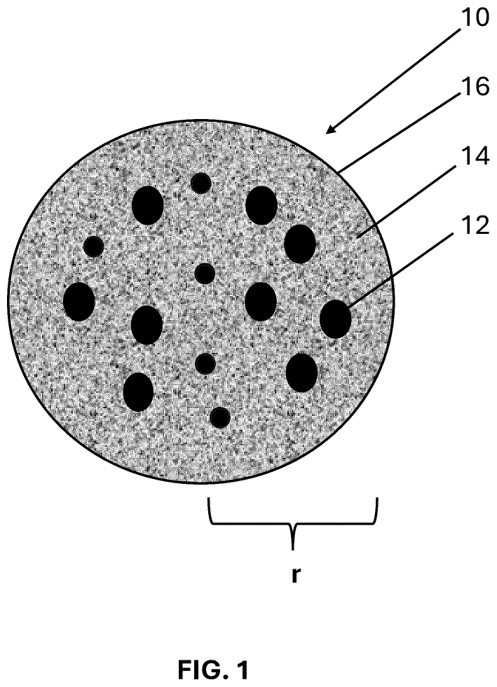

Referring now to FIG. 1, an inventive particle is shown generally at 10. The particle 10 contains struvite domains 12 depicted graphically as black circles and magnesium phosphates 14 depicted graphically as a stippled matrix that defines a particle surface 16 with a particle radius, r. The particle surface 16 is believed to maintain a non-zero, zeta charge value.

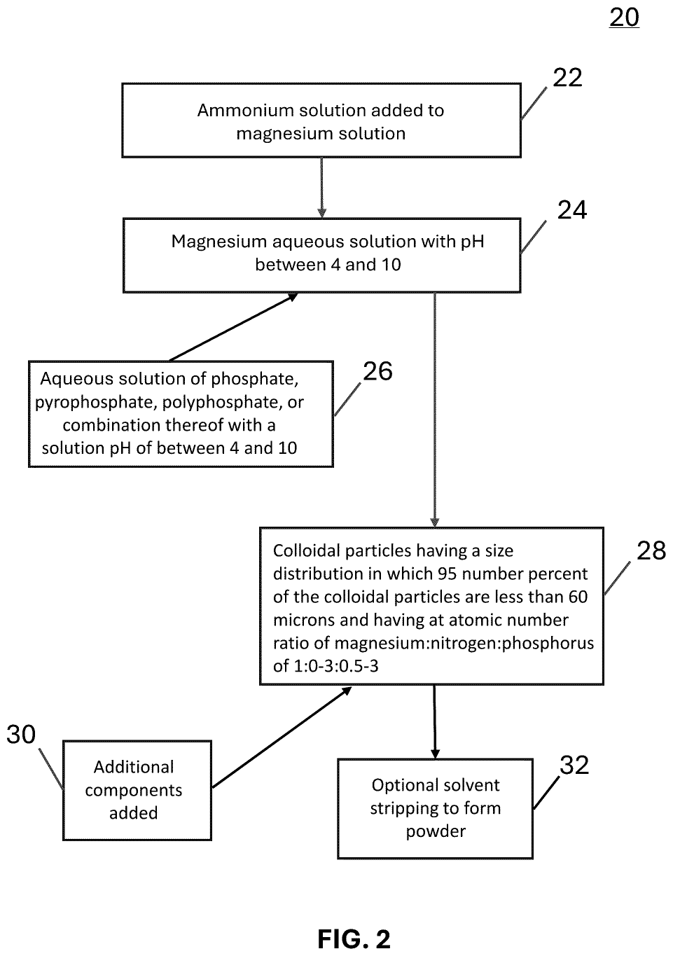

A method 20 of making an inventive composition is shown in FIG. 2. An ammonium solution is added to modify a magnesium solution (Block 22) to yield a magnesium aqueous solution with a pH of between 4 and 10 (Block 24). An aqueous solution of phosphate, pyrophosphate, polyphosphate, or combination thereof and having a solution pH of between 4 and 10 (Block 26) is added to the magnesium aqueous solution (Block 24) to form colloidal particles having a size distribution in which 95 number percent of the colloidal particles are less than 60 microns and having at atomic number ratio of magnesium:nitrogen:phosphorus of 1:0-3:0.5-3 (Block 28). Additional components are subsequently added to the colloidal particles (Block 30) or alternatively a stabilizer is already present in the composition of Block 28. The composition produced at Block 28 or in combination with Block 30 is amenable to an optional solvent stripping to form a reconstitutable concentrate or powder (Block 32). It is appreciated that a concentrate or powder facilitates storage and transport to a situs of field application. A kit is readily provided containing such a concentrate or powder along with instructions for how to suspend the colloidal particles in water to form an aqueous suspension and apply the aqueous suspension to a field as a fertilizer.

The phosphates are present as sodium salts, ammonium salts, potassium salts, or a combination thereof. Typically, the aqueous phosphates solution (Block 26) in some embodiments is from 5 to 70 total weight percent polyphosphate, regardless of whether other phosphates are present therein. To promote colloidal formation relative to precipitate, in some inventive embodiments, the aqueous phosphates solution is added dropwise or similar restrictive methods of slow addition or injection to promote colloidal nucleation relative to particle growth. In still other inventive embodiments, the limited addition rate of aqueous phosphates solution is accompanied by shear forces applied to the magnesium aqueous solution of block 24 during the addition. In some inventive embodiments, the magnesium aqueous solution of block 24 is subjected to stirring, bubbling, or agitation during the addition of the solution of at least one of phosphate, pyrophosphate, polyphosphate, or combination thereof and having a solution pH of between 4 and 10 (Block 26).

A process of fertilizing a crop of target plants includes the application of an inventive composition to the crop. Following application allowing sufficient time for the composition to promote growth of the crop. The inventive composition is typically applied in an amount of between 2 to 45 kilograms phosphorus per acre, of whether the phosphorus is plant-available or soluble. The amount is readily adjusted based on factors that include field conditions such as soil moisture content, weather forecast, soil type, target plant root development to mitigate phosphorus run-off. In some inventive embodiments, phosphate run-off from the crop to less than 5% of the applied quantity per acre.

The present invention is further detailed with respect to the following non-limiting examples. These examples are intended to illustrate specific embodiments of the present invention.

### Example 1

A controlled test conducted as a “Phosphorus Efficiency Study” was performed to measure phosphate run-off for an inventive composition relative to comparative, conventional compositions when applied to a corn crop. The test was meant to be indicative of the environmental fate of applied phosphorous that was not used or absorbed by the targeted plant and could potentially contribute to unwanted runoff.

The experimental set up and procedure was as follows:

A series of two-gallon plant pots were filled with growing media in the form of SAKRETE® Play Sand™. The planting pots were of nine-inch diameter with a surface area of 63.6 inches² or equivalently 0.44 ft². Corn seeds were planted in each pot at a depth of two inches. The pots were arranged in a randomized complete block design. Each pot was watered for one minute on a daily basis. Fertilizer was applied in liquid form with the seed and was followed by broadcast treatments placed on top of seed area immediately after planting, where application was Full rate P=40 lb P₂O₅/A and Half rate P=20 lb P₂O₅. The amount of fertilizer that was applied was based on Extension Bulletin E-2567 (New), July 1995 entitled “Tri-State Fertizer Recommendations for Corn, Soybeans, Wheat & Alfalfa” as found at https://www.extension.purdue.edu/extmedia/ay/ay-9-32.pdf using the following:

$$lb {P}_{2} {O}_{5} to apply = ( CL ‐ STL ) \times 5 + ( YP \times CR ) \\ 84 = ( ( 15 - 13 ) * 5 ) + ( 200 * 0.37 ) \qquad Eq . 1$$

However, starter fertilizers were used 20-40 lbs of P₂O₅ quantities. The remainder is made up with foliar treatments. Replicates were twelve per treatment. Replicate size was determined by the following equation:

$$n = {( z * st dev / E )}^{2} = Replicate size \qquad Eq . 2$$

Leachate was collected in a bucket under each pot. The plant was suspended over the leachate at all times and did not touch the collected leachate.

Fertilizers used in the comparative study included SMARTPHOS® DG (dispersing granuals) 4-22-0 with struvite from THE ANDERSONS®, Diammonium phosphate (DAP) 18-46-0 from THE ANDERSONS®, Crystal Green (5-28-0-10 Mg)® from Ostara Nutrient Recovery Technologies, Syncro™ 50 (8-40-0-5 Mg) from Ostara Nutrient Recovery Technologies, XP312 Struvite Slurry (11-8-0-2 Mg) liquid fertilizer which is an embodiment of the inventive fertilizer composition as disclosed herein and is used in Treatments 11 and 12 as described below.

Treatments conducted during the experiment were as follows:

$$40 lb {P}_{2} {O}_{5} / 0.22 = 181.8 lb product / A \qquad Treatment 1$$

$$20 lb {P}_{2} {O}_{5} / 0.22 = 90.9 lb product / A \qquad Treatment 2$$

$$40 lb {P}_{2} {O}_{5} / 0.46 = 86.9 lb product / A \qquad Treatment 3$$

$$20 lb {P}_{2} {O}_{5} / 0.46 = 43.5 lb product / A \qquad Treatment 4$$

$$40 lb {P}_{2} {O}_{5} / 0.28 = 142.9 lb product / A \qquad Treatment 5$$

$$20 lb {P}_{2} {O}_{5} / 0.28 = 71.4 lb product / A \qquad Treatment 6$$

$$40 lb {P}_{2} {O}_{5} / 0.4 = 100 lb product / A \qquad Treatment 7$$

$$20 lb {P}_{2} {O}_{5} / 0.04 = 50 lb product / A \qquad Treatment 8$$

$$10 ‐ 34 ‐ 0 weighs 11.7 lb / gal , so there 3.9 lb {P}_{2} {O}_{5} per gal \\ 40 lb {P}_{2} {O}_{5} / 3.98 lb = 10.1 gal 10 ‐ 34 ‐ 0 \qquad Treatment 9$$

$$10 ‐ 34 ‐ 0 weighs 11.7 lb / gal , so there 3.9 lb {P}_{2} {O}_{5} per gal \\ 20 lb {P}_{2} {O}_{5} / 3.98 lb = 5 gal 10 ‐ 34 ‐ 0 \qquad Treatment 10$$

$$XP 312 Struvite ( 11 ‐ 8 ‐ 0 ) weighs 10.2 lb / gal , so there is 0.82 lb {P}_{2} {O}_{5} per gal \\ 40 lb {P}_{2} {O}_{5} / \text{.82} lb = 48.7 gal of XP 312 \qquad Treatment 11$$

$$XP 312 Struvite ( 11 ‐ 8 ‐ 0 ) weighs 10.3 lb / gal , so there is 0.82 lb {P}_{2} {O}_{5} per gal \\ 20 lb {P}_{2} {O}_{5} / lb = 24.4 gal of XP 312 \qquad Treatment 12$$

### Treatment 13:

None

Table 1 provides a summary of the fertilizers used in the comparative experiment and includes P rate, application rate, application rate per pot.

TABLE 1

| Treatment | | P | Application | | Application | |
|---|---|---|---|---|---|---|
| Number | Treatment | Rate | Rate | | Rate per Pot | |
| 1 | SmartPhos DG | Full | 181.8 | lb/A | 0.84 | g |
| | 4-22-0 | | | | | |
| 2 | SmartPhos DG | Half | 90.9 | lb/A | 0.42 | g |
| | 4-22-0 | | | | | |
| 3 | DAP 18-46-0 | Full | 86.9 | lb/A | 0.40 | g |
| 4 | DAP 18-46-0 | Half | 43.5 | lb/A | 0.20 | g |
| 5 | Crystal Green | Full | 142.9 | lb/A | 0.66 | g |
| | (5-28-0-10 Mg) | | | | | |
| 6 | Crystal Green | Half | 71.4 | lb/A | 0.33 | g |
| | (5-28-0-10 Mg) | | | | | |
| 7 | Syncro 50 | Full | 100 | lb/A | 0.46 | g |
| | (8-40-0-5 Mg) | | | | | |
| 8 | Syncro 50 | Half | 50 | lb/A | 0.23 | g |
| | (8-40-0-5 Mg) | | | | | |
| 9 | 10-34-0 | Full | 10.1 | gal/A | 386 | μL |
| 10 | 10-34-0 | Half | 5 | gal/A | 193 | μL |
| 11 | XP312 Struvite Slurry | Full | 48.7 | gal/A | 1.86 | mL |
| | (11-8-0-2 Mg) | | | | | |
| 12 | XP312 Struvite Slurry | Half | 24.4 | gal/A | 930 | μL |
| | (11-8-0-2 Mg) | | | | | |

| | | | | |
|---|---|---|---|---|
| 13 | Check - None | N/A | N/A | N/A |

Trial data and observations for the experiment were collected as follows and at these timed intervals:
At seven days: a photo of each replicate and plant height was measured.
At fifteen days: A photo of each replicate and plant height was measured. Total phosphorus in the leachate was lab measured based on a composite sample taken for each treatment of the leachate collections from all replicates. The sampling procedure used was to stir leachate and use a beaker to collect 20 mL from each replicate to fill sample bottle.
At thirty days: the fifteen day procedure was repeated.
At forty-five days: the fifteen day procedure was repeated.
   It is noted that for Dissolved/Soluble Orthophosphates the following methodology was used as obtained from the United States Environmental Protection Agency archive.

It is further noted that for determination of Total Dissolved/Soluble Phosphorous, the methodology used relied on filtering in the same way as orthophosphates and was run on ICP analysis as is. The resulting SRP, TSP, and TP values for the trials resulted.

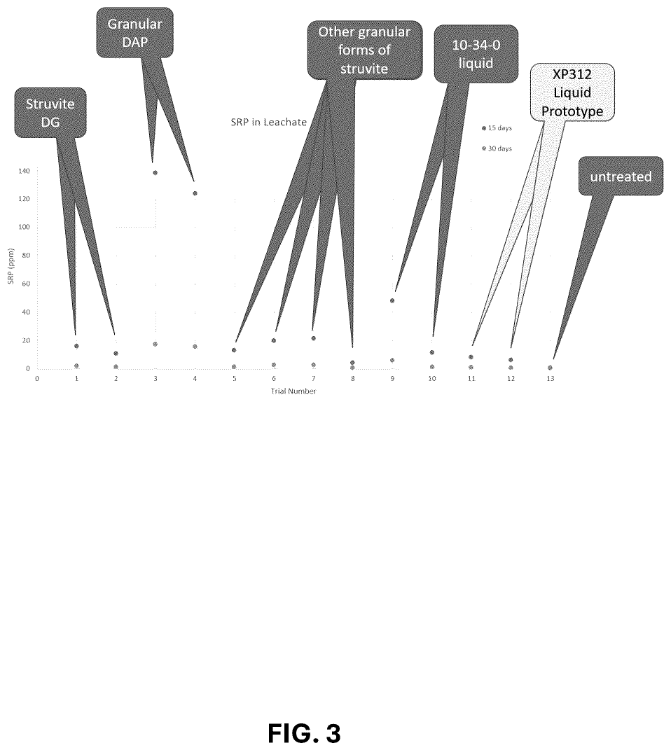

Referring now to FIG. 3 the results of the treatment numbers are shown in a graph that is a plot of phosphate run-off for an embodiment of inventive composition relative to comparative, conventional compositions. As evident from the data points in FIG. 3 the XP312 liquid prototype (Trial number 11 and 12) as disclosed herein measured the lowest in terms of SRP in parts per million (ppm) in the leachate as measured at 15 days and 30 days.

### Example 2

The inventive composition of the XP312 liquid used Example 1 was produced with the further addition of 5 total weight percent xanthan gum with comparable results to Example 1 and relative to the Comparative Examples.

### Examples 3-9

The composition of Example 1 was produced with the further addition of 0.0001 total weight percent of root acid phosphatase, indole-3-butyric acid, abscisic acid, gibberellin, Karrikins, or naphthalene carboxylic acid, with comparable results to Example 1 and relative to the Comparative Examples.

### Example 10

The composition of Example 1 was produced with the further addition of 5 total weigh percent of polyphosphate aqueous solution that was from 5 to 70 total weight percent ammonium polyphosphate with comparable results to Example 1 and relative to the Comparative Examples.

Any patents or publications mentioned in this specification are indicative of the level of those skilled in the art to which the invention pertains. These patents and publications are herein incorporated by reference to the same extent as if each individual publication was specifically and individually indicated to be incorporated by reference.

One skilled in the art will readily appreciate that the present invention is well adapted to carry out the objects and obtain the ends and advantages mentioned, as well as those inherent therein. The present methods, procedures, treatments, molecules, and specific compounds described herein are presently representative of preferred embodiments, are exemplary, and are not intended as limitations on the scope of the invention. Changes therein and other uses will occur to those skilled in the art which are encompassed within the spirit of the invention as defined by the scope of the claims.

1. A fertilizer composition comprising:
an aqueous solution; and
colloidal particles suspended in the aqueous solution, said colloidal particles having a size distribution in which 95 number percent of said colloidal particles are less than 60 microns and having at atomic number ratio of magnesium:nitrogen:phosphorus of 1:0-3:0.5-3.

2. The composition of claim 1 wherein said phosphorus in said colloidal particles is more than 90 percent by weight in the form of a phosphate, a polyphosphate, a pyrophosphate, or a combination thereof.

3. The composition of claim 2 wherein said phosphate has a solubility constant at standard temperature and pressure of less than 10⁻³.

4. The composition of claim 1 wherein said colloidal particles have a size distribution in which 90 number percent of said colloidal particles are between 5 and 50 microns.

5. The composition of claim 1 wherein said colloidal particles have a size distribution in which 80 number percent of said colloidal particles are between 8 and 30 microns.

6. The composition of claim 1 wherein said colloidal particles are present from 2 to 40 total weight percent of the composition.

7. The composition of claim 1 wherein said colloidal particles are present from 40 to 99 total weight percent of the composition.

8. The composition of claim 1 wherein said aqueous solution has a pH of between 3 and 11.

9. The composition of claim 1 wherein said aqueous solution has a pH of between 5 and 9.

10. The composition of claim 1 further comprising a stabilizer in said aqueous solution.

11. The composition of claim 10 wherein said stabilizer is xatham gum, guar gum, a starch, agarose, a water soluble cellulosic, pectin, gelatin, clay, xanthan gum, methyl cellulose, methyl hydroxyethyl cellulose, microfibrillated cellulose, butyl glucoside, polyvinyl alcohol, micaceous powders, carboxymethyl cellulose, or a combination thereof.

12. The composition of claim 11 wherein said stabilizer is present from 0.001 to 10 total weight percent.

13. The composition of claim 1 further comprising a root acid phosphatase, or a plant growth modifiers of indole-3-butyric acid, root acid phosphatase, cytokinins, auxins, abscisic acid, gibberellins, amino acids, carboxylic acids or salts, Karrikin's, naphthalene carboxylic acid, or a combination thereof.

14. A kit comprising:
said colloidal particles of claim 1; and
instructions for how to suspend said colloidal particles in water to form an aqueous suspension and apply said aqueous suspension to a field as a fertilizer.

15. The kit of claim 14 further comprising a stabilizer.

16. The kit of claim 14 further comprising a root acid phosphatase.

17. A process of fertilizing a crop comprising:
applying said composition of claim 1 to the crop; and
allowing sufficient time for said composition to promote growth of the crop.

18. The process of claim 17 wherein said composition is applied in an amount of between 2 and 45 kilograms phosphorus per acre.

19. The process of claim 17 further comprising limiting phosphate run-off from the crop to less than 5% of the applied quantity per acre.
